(19) United States
(12) Patent Application Publication
(10) Pub. No.: US 2004/0044928 A1
(43) Pub. Date: Mar. 4, 2004

(54) Test device and method for information transmission interfaces

(76) Inventors: Der-Shyong Chang, Taipei (TW); Chih-Sheng Cheng, Taipei (TW)

Correspondence Address: BIRCH STEWART KOLASCH & BIRCH, PO BOX 747, FALLS CHURCH, VA, 22040-0747, US

(21) Appl. No.: 10/301,793

(22) Filed: Nov. 22, 2002

(30) Foreign Application Priority Data
Sep. 4, 2002 (TW) 091120143

(51) Int. Cl. H04B 1/74

(52) U.S. Cl. 714/43

(57) ABSTRACT

This specification discloses a test device and method for information transmission interfaces. An information processing system is installed with a test mechanism. An element is connected to an information transmission interface of the information processing system to form a loop. The test mechanism sends out a test signal to the loop through an information transmission interface. The test signal is then sent back to the information processing system for comparison via another information transmission interface. This achieves the goal of testing information transmission interfaces. The invention can save the cost in comparison with the conventional tools.

### BACKGROUND OF THE INVENTION

1. Field of Invention

The invention relates to a test device and, in particular, to a test device and method for the information transmission interfaces of information processing systems.

2. Related Art

The information processing system has increasingly many functions. Therefore, many peripheral devices are devised to corporate with the information processing system for processing information. If a user wants to use computer peripherals such as printers, scanners, keyboards, and mice, an information transmission interface is required to build up the communications between the information processing system and the peripheral devices.

The information transmission interface has the functions of connecting the peripheral devices together and processing a huge amount of information transmission jobs. Taking the universal serial bus (USB) as an example, it has convenient functions such as plug and play (PNP) and hot insertion-hot swapping. Therefore, its use becomes more popular.

Due to the indispensability of the information transmission interfaces, a normal information processing system is often provided with several information transmission interfaces in order to communicate with peripheral devices. However, the information transmission interfaces have to be tested before the information processing systems are shipped for sale. Taking the USB as an example, FIG. 1 shows the structure of a conventional information transmission interface test tool. To test a usual USB port, a devoted test device 30 has to be connected to the port on the information processing system. Such test devices are usually very expensive. A professional information processing system manufacturer has to invest a fair amount of money in these test devices, which is very uneconomical.

From the above-mentioned test technique in the prior art, one sees that the conventional test device and method cost a lot. Therefore, how to achieve the goal of testing the information transmission interfaces while at the same time lowering the cost has been an important issue in the field.

### SUMMARY OF THE INVENTION

In view of the foregoing problems, it is an objective of the invention to provide a test device and method for information transmission interfaces. The goal is to utilize an externally connected loop along with a test mechanism to test more than one information transmission interface at a time.

Another objective of the invention is to provide a test device and method for information transmission interfaces that can lower the cost. An external loop is connected to information transmission interfaces of an information processing system to form a test path. A test code is sent to test whether the signal transmission on the information transmission interface is normal. In comparison with the conventional test devices, the invention can greatly lower the test cost.

The disclosed test device and method for the information transmission interfaces first provide a test mechanism within the information processing system. A loop unit is connected to two information transmission interfaces of the information processing system. The test mechanism sends out a test signal to the loop unit via one information transmission interface. The test signal is then sent back to the information processing system for comparison via the other information transmission interface. This achieves the goal of testing information transmission interfaces.

### BRIEF DESCRIPTION OF THE DRAWINGS

The invention will become more fully understood from the detailed description given hereinbelow illustration only, and thus are not limitative of the present invention, and wherein:

FIG. 1 shows the system structure of a conventional test tool for testing the information transmission interface;

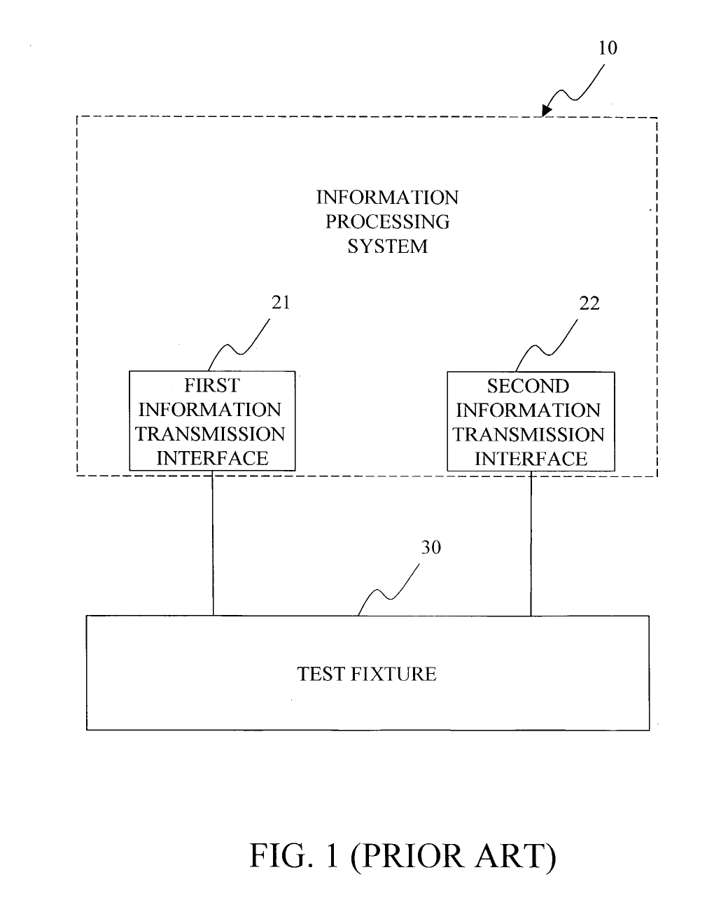

FIG. 2 is a first embodiment of the disclosed test device and method for information transmission interfaces;

FIG. 3 is a flowchart of the steps in the disclosed test method;

FIG. 4 is a second embodiment of the disclosed test device and method for information transmission interfaces;

FIG. 5 is a third embodiment of the disclosed test device and method for information transmission interfaces; and

FIG. 6 is a fourth embodiment of the disclosed test device and method for information transmission interfaces.

### DETAILED DESCRIPTION OF THE INVENTION

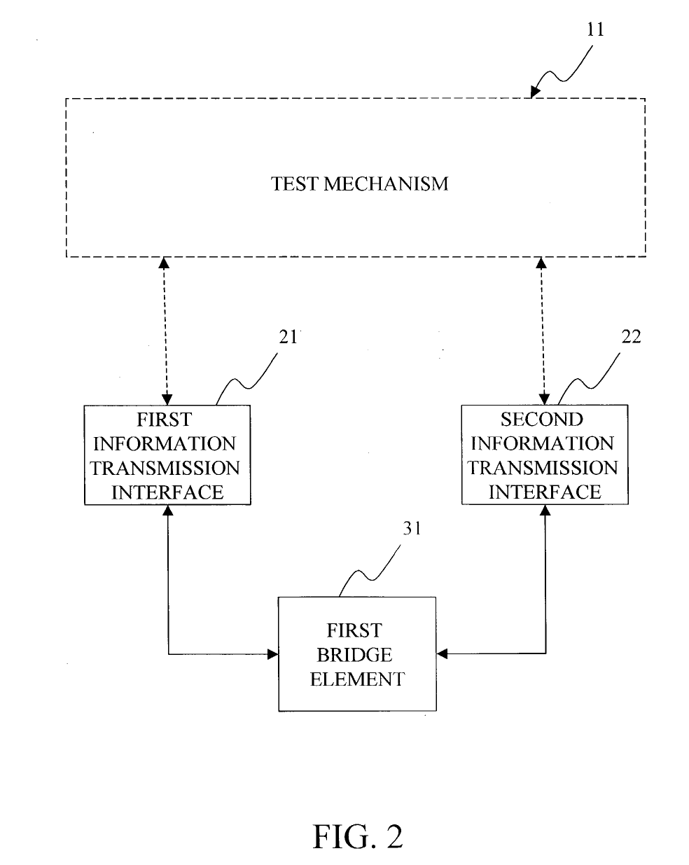

As shown the FIG. 2, the disclosed test device for information transmission devices is connected to an information processing system. The information processing system has two information transmission interfaces (the first information transmission interface 21 and the second information transmission interface 22). The test device has a test mechanism 11 and a bridge element 31. One terminal of the first bridge element 31 is connected with the first information transmission interface 21, and another terminal is connected with the second information transmission interface 22, forming a loop for testing. The test mechanism 11 is installed inside the information processing system. It is used to generate a test code, which can be a data string. The test code is transmitted to the first bridge element 31 via the first information transmission interface 21 for the test mechanism 11 to determine whether the transmission is successful. The first bridge element 31 then sends the test code back to the test mechanism 11 via the second information transmission interface 22. The test mechanism 11 determines whether the test code is correctly received. After receiving the test code, the test mechanism compares it with the original test code, thereby determining whether the transmission function of the information transmission interfaces is all right. Alternatively, the test code can be sent out via the second information transmission interface 22 to the first bridge, and the test mechanism 11 determines whether the transmission is successful. The test code is then returned by the first bridge element 31 back to the test mechanism 11 via the first transmission interface 21. The test mechanism 11 determines whether the reception is successful. Finally, the test mechanism 11 compares the received code with the original test code to see if the transmission function of the information transmission interfaces is all right.

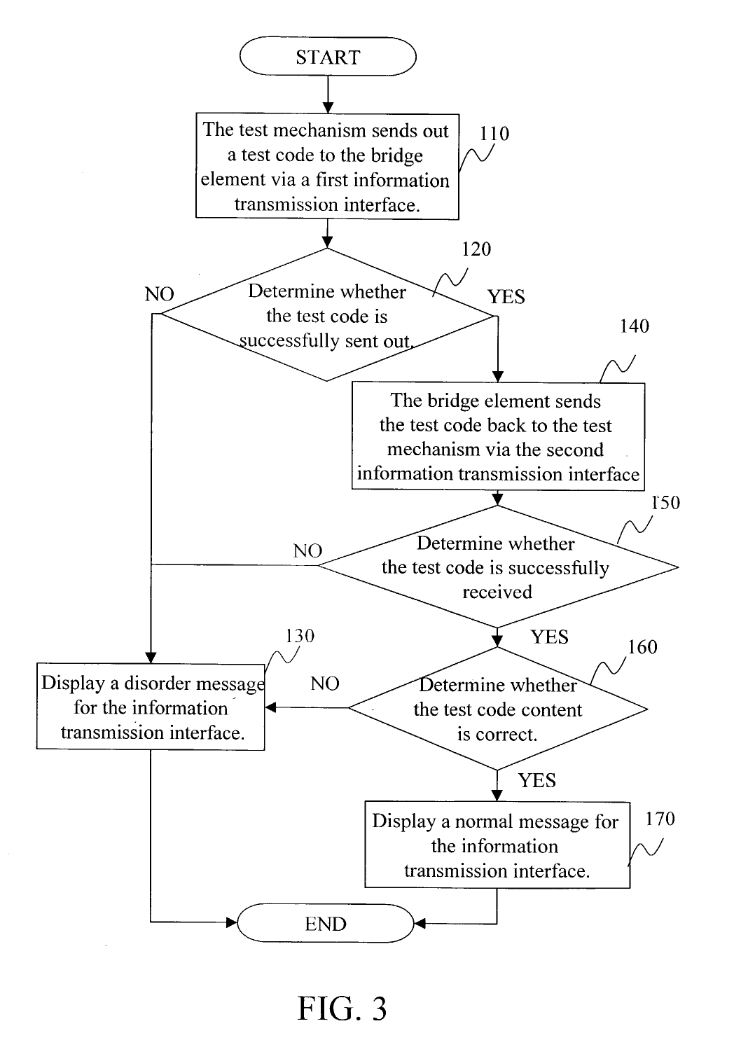

In the following text, we use FIG. 3 to explain the disclosed test method. First, a test mechanism sends out a test code to a bridge element via a first information transmission interface (step 110), and determines whether the test code is successfully sent out (step 120). If the transmission fails, it means that the first transmission interface is out of order and the system displays an information transmission interface disorder message (step 130). If the test code is successfully sent out, then it means that the first information transmission interface functions normally. Afterwards, the bridge element sends the test code back to the test mechanism in the information processing system via the second information transmission interface (step 140). The test mechanism determines whether the test code is successfully received (step 150). If the reception fails, then it means that the second information transmission interface is out of order and the system displays an information transmission interface disorder message (step 130). If the test code is successfully received, then it means that the second information transmission interface functions normally. Finally, the test mechanism determines whether the received test code content is the same as the original one (step 160). If the received test code is correct, then the function of the information transmission interfaces is all right. The system displays a message saying that the information transmission interfaces are functioning correctly (step 170). If the received test code has errors, then it means that the information transmission interfaces still have problems, and the system displays an information transmission interface disorder message (step 130).

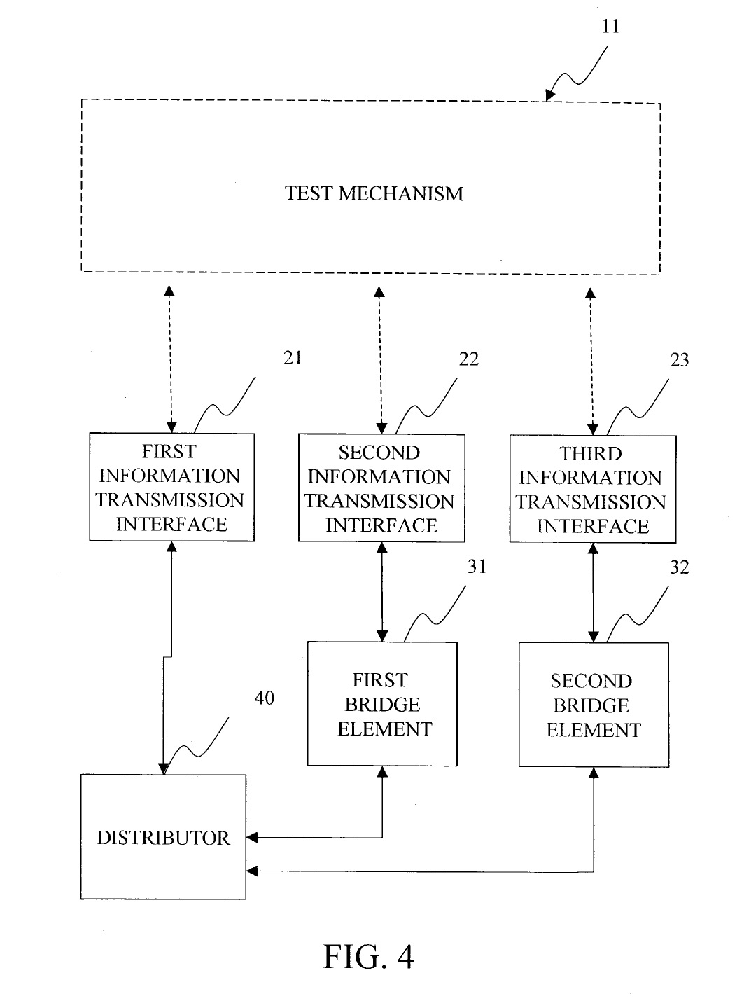

In FIG. 4, we demonstrate another embodiment to further explain the invention. A shown in the drawing, the information processing system has three information transmission interfaces, the first information transmission interfaces 21, the second information transmission interfaces 22, and the third information transmission interfaces 23. The information transmission interfaces may be universal serial bus (USB) ports. When the test mechanism 11 sends out a test code, the test code is sent to a distributor 40 via the first information transmission interface. This distributor may be a USB hub, which further sends the test code to a first bridge element 31 and a second bridge element 32. In addition to sending the test code from the first bridge element 31 back to the test mechanism 11 via the second information transmission interface 22, it can also be sent from the second bridge element 32 back to the test mechanism 11 via the third information transmission interface 23. The test mechanism determines whether the transmission and reception are successful. Finally, the test mechanism 11 compares the test codes returned via the second information transmission interface 22 and the third information transmission interface 23 with the test code sent out via the first information transmission interface 21, determining whether the function of the information transmission interfaces are all correct. The test for the third information transmission interface 23 needs not to be performed after the second information transmission interface 22. The test code can be transmitted between the second information transmission interface 22 and the third information transmission interface 23. The first, second, and third information transmission interfaces herein are distinguished only for the purpose of explanation. In reality, one can choose one of the three information transmission interfaces to connect with the distributor, and the distributor along with the bridge elements are connected to form test loops for the rest information transmission interface.

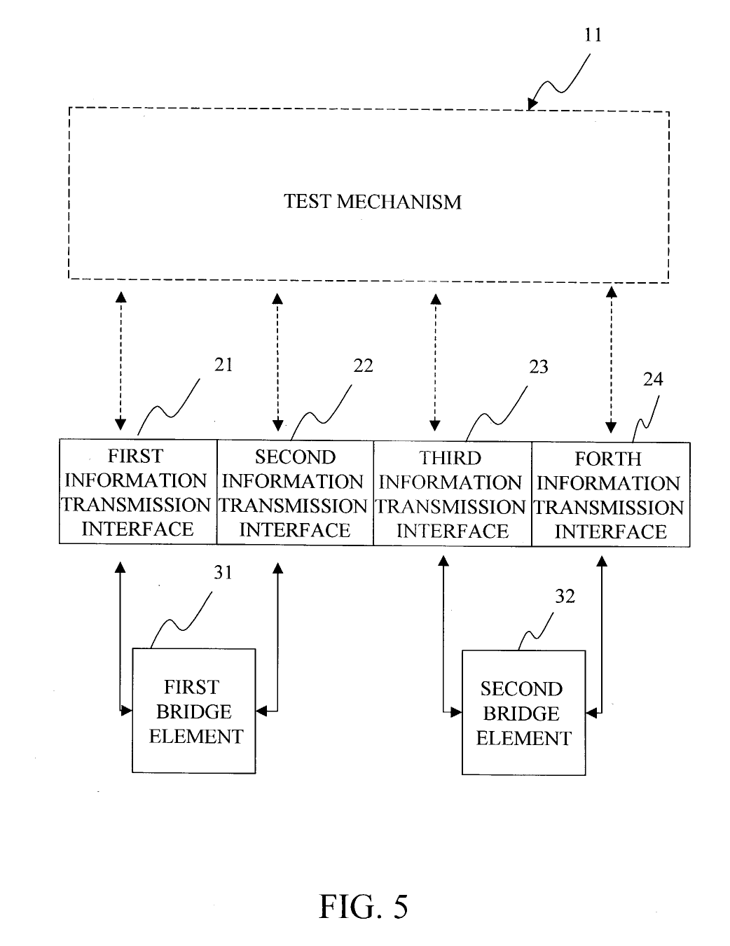

We further provide another embodiment to explain the disclosed test device and method, as shown in FIG. 5. Suppose there are four information transmission interfaces (e.g. four USB ports) installed on the information processing system, the first information transmission interface 21, the second information transmission interface 22, the third information transmission interface 23, and the fourth information transmission interface 24, respectively. The first information transmission interface 21 and the second information transmission interface 22 can be connected with the first bridge element 31 to form a test loop. The third information transmission interface 23 and the fourth information transmission interface 24 can be connected with the second bridge element 32 to form another test loop. When the test mechanism 11 sends out a test code, the test code is transmitted to the first bridge element 31 via the first USB part 21. The first bridge element 31 then returns the test code back to the test mechanism 11 via the second information transmission interface 22. Likewise, the test code is also sent to the second bridge element 32 via the third information transmission interface 23. The second bridge element 32 then returns the test code to the test mechanism 11 via the fourth information transmission interface 24. The test mechanism 11 checks whether the above transmissions and receptions are successful and compares the returned test code with the original code, determining whether the function of the information transmission interfaces is all right.

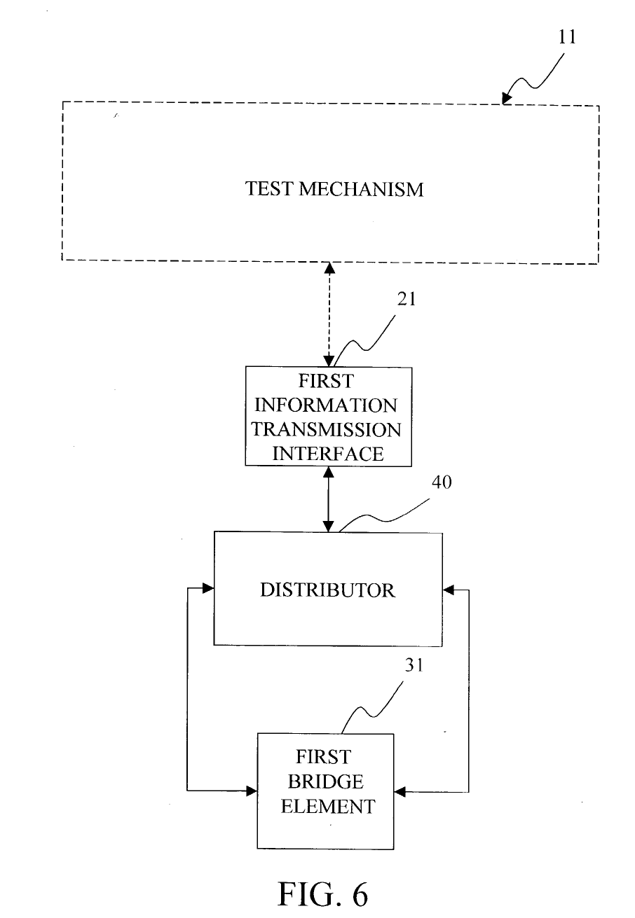

We show yet another embodiment in FIG. 6. If one only needs to test a USB part 21, the test code sent out from the test mechanism 11 is transmitted to the distributor 40 via the first information transmission interface 21. The test code is then returned back to the information processing system via the loop formed by the distributor 40 and the first bridge element 31. The test mechanism 11 determines whether the transmission and reception are successful and compares the received test code with the one being sent out by the test mechanism 11. This configuration can also determine an information transmission interface functions correctly.

In the above-mentioned four embodiments, the bridges can be USB host bridges and the test code can be any data string generated by the test mechanism. Although the connection details in the four embodiments are slightly different, the implementation steps are very similar. Through these embodiments, one sees that the invention does not only apply to testing an even number of information transmission interfaces, but also any odd number of information transmission interfaces.

### EFFECTS OF THE INVENTION

The technique disclosed in the invention enables a test mechanism in an information processing system to test several information transmission interfaces via bridge elements. Taking the test device that can simultaneously test eight connection ports in the prior art as an example, the cost is about $1,500. The best-quality bridge element costs about $60; so it will only cost about $240. For a manufacturer that mass produces information systems, if it has twenty production lines and fifteen test devices in each production line then it needs three hundred test devices, which cost about $72,000. Therefore, the company can save as much as $360,000.

Consequently, one does not need to purchase expensive test devices for information transmission interfaces if one chooses to use the disclosed test device and method. The invention can save a considerably amount of manufacturing cost.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A test method for information transmission interfaces using more than one bridge elements to connect at least one information transmission interface in an information processing system to form a test loop, the test method comprising the steps of:
sending out a test code from a test mechanism to a terminal of the bridge via the information transmission interface;
the test mechanism's determining whether the test code transmission is successful and returning the test code back to the test mechanism via another terminal of the bridge element;
the test mechanism's determining whether the test code reception is successful; and
the test mechanism's comparing the received test code and the original test code, and displaying a message about whether the information transmission interface functions correctly.

2. The test method of claim 1, wherein the test mechanism displays a disorder message when the transmission of the test code fails.

3. The test method of claim 1, wherein the test mechanism displays a disorder message when the reception of the test code fails.

4. The test method of claim 1, wherein the test mechanism displays a disorder message when comparison between the received test code and the original test code indicates errors.

5. The test method of claim 1, wherein the information transmission interface is a universal serial bus (USB) port.

6. The test method of claim 1, wherein the bridge element is a USB host bridge.

7. The test method of claim 1, wherein a distributor is further provided between the information transmission interface and the bridge element.

8. The test method of claim 7, wherein the distributor is a USB hub.

9. A test device for information transmission interfaces connected with an information processing system that contains at least one information transmission interface, the test device comprising:
at least one bridge element connecting with the information transmission interface to form a loop; and
a test mechanism, which is installed inside the information processing system and connected with the loop for generating a test code;
wherein the test code is transmitted to the loop to check whether the transmission is successful, the test code is returned by the loop back to the test mechanism to check whether the reception is successful, the received test code is compared with the transmitted test code to check whether they are identical, and a message about whether the information transmission interface functions correctly is displayed.

10. The test device of claim 9, wherein the information transmission interface is a USB port.

11. The test device of claim 9, wherein the test code is a data string.

12. The test device of claim 9, wherein the bridge element is a USB host bridge.

13. The test device of claim 9, wherein a distributor is provided between the bridge element and the information transmission interface.

14. The test device of claim 13, wherein the distributor is a USB hub.
